(19) United States
(12) Patent Application Publication
(10) Pub. No.: US 2015/0063831 A1
(43) Pub. Date: Mar. 5, 2015

(54) BURST MODE OPTICAL RECEIVER AND MEMORY SYSTEM USING THE SAME

(71) Applicant: Samsung Electronics Co., Ltd., Suwon-si (KR)

(72) Inventors: Amir H. Nejadmalayeri, Hwaseong-si (KR); Sunil Parmar, Suwon-si (KR); Hyunil Byun, Seongnam-si (KR); In Sung Joe, Seoul (KR)

(21) Appl. No.: 14/312,165

(22) Filed: Jun. 23, 2014

(30) Foreign Application Priority Data
Sep. 5, 2013 (KR) 10-2013-0106776

(51) Int. Cl. H04B 10/60; H04B 10/2575

(52) U.S. Cl. CPC H04B 10/60; H04B 10/2575
USPC 398/212

(57) ABSTRACT

A burst mode optical receiver includes a pre-amplifier configured to convert an optical burst mode signal into a voltage signal, a reference controller configured to determine a reference voltage for the voltage signal in response to a mode signal from a host indicating an interval during which the voltage signal is DC balanced, and a main amplifier configured to restore the voltage signal to a data signal based on the reference voltage. Related methods of operation are also discussed.

### CROSS-REFERENCE TO RELATED APPLICATIONS

This application claims priority under 35 U.S.C. §119 to Korean Patent Application No. 10-2013-0106776 filed Sep. 5, 2013, in the Korean Intellectual Property Office, the disclosure of which is hereby incorporated by reference herein in its entirety.

### BACKGROUND

The inventive concepts described herein relate to burst mode optical receivers, and more particularly, to memory systems including the same.

A Passive Optical Network (PON) is a high-speed packet service network that may be used to transmit high-speed multimedia signals. With a PON, an Optical Line Terminal (OLT) and a plurality of Optical Network Units (ONUs) may be implemented in a point-to-multipoint manner. A burst mode optical receiver may convert an optical signal into an electrical signal during a communication process using an OLT and an ONU.

Data received by an optical receiver of the ONU may have the same phase and output level, while data received by the OLT may have different phases and output levels. A burst mode optical receiver may be used to receive different sizes and phases of data of each packet and to restore the received data such that sizes and phases of packets become equal to one another. The burst mode optical receiver may have characteristics such as fast reaction speed, wide operating range on the strength of incident light, and/or short delay time. The burst mode optical receiver typically sets a data reference voltage for different levels of signals within a short time.

### SUMMARY

According to some embodiments of the inventive concepts, a burst mode optical receiver includes a reference controller configured to receive a voltage signal generated from an optical burst mode signal. The reference controller is configured to determine a reference voltage for the optical burst mode signal in response to a mode signal indicating a training interval during which the voltage signal is DC balanced, such that same or equal number of ‘1’ bits and ‘0’ bits are indicated by the voltage signal during the training interval.

In some embodiments, the reference controller may be configured to calculate an average of the voltage signal over the training interval in response to the mode signal to determine the reference voltage.

In some embodiments, the reference controller may be configured to hold and output the reference voltage outside of the training interval responsive to determination thereof.

In some embodiments, the reference controller may be configured to switch between operation to calculate the average of the voltage signal and operation to hold and output the reference voltage in response to the mode signal.

In some embodiments, a main amplifier may be configured to maintain an amplitude of the voltage signal in response to a control signal from the reference controller to output a data signal. The control signal may indicate the reference voltage.

In some embodiments, the reference controller may be configured to determine the reference voltage without use of a peak detector.

Some aspects of embodiments of the inventive concept are directed to providing a burst mode optical receiver that receives a burst mode signal from a host, the burst mode optical receiver comprising a pre-amplifier configured to convert the burst mode signal into a voltage signal; a reference controller configured to determine a data reference signal of the voltage signal in response to a mode signal, indicating a training interval being an interval where the burst mode signal is DC balanced, provided from a host; and a main amplifier configured to restore the voltage signal to a data signal based on the data reference voltage.

In exemplary embodiments, in the training interval, the number of ‘1’ bits included in the burst mode signal is equal to the number of ‘0’ bits included in the burst mode signal.

In exemplary embodiments, in the training interval, the burst mode signal is a signal having such a pattern that at least one ‘1’ bit and at least one ‘0’ bit or a sequence of ‘1’ bits and a sequence of ‘0’ bits are in turn received.

In exemplary embodiments, the main amplifier restores the voltage signal to the data signal having a predetermined uniform amplitude based on the data reference voltage.

In exemplary embodiments, the reference controller calculates an average of the voltage signal during the training interval of the burst mode signal in response to the mode signal and outputs the calculated average as the data reference voltage.

In exemplary embodiments, the reference controller comprises an average/hold circuit operating in one selected from a plurality of driving modes, and the driving modes of the average/hold circuit comprise an average mode for calculating an average of the voltage signal and a hold mode for holding the calculated average to be output as the data reference voltage. The average/hold circuit operates in one of the average mode and the hold mode in response to the mode signal.

In exemplary embodiments, the average/hold circuit comprises an average capacitor; a first switch configured to provide the voltage signal to the average capacitor in the average mode, in response to the mode signal; and a second switch configured to output a voltage stored in the average capacitor as the data reference voltage in the hold mode, in response to the mode signal.

In exemplary embodiments, the average/hold circuit comprises an average capacitor; a switch configured to provide the voltage signal to the average capacitor in the average mode, in response to the mode signal; and a comparator configured to compare a voltage stored in the average capacitor and the data reference voltage; a counter configured to update a count in response to the comparison result of the comparator; and a digital-to-analog converter configured to generate the data reference voltage digitized based on the count value.

In exemplary embodiments, the counter increases the count when the voltage stored in the average capacitor is higher than the data reference voltage, and the digital-to-analog converter generates the data reference voltage having a level that is increased in proportion to an increase in the count value.

In exemplary embodiments, the average/hold circuit further comprises a multiplexer unit configured to provide one of the voltage stored in the average capacitor and the data reference voltage to a positive input terminal of the comparator and the other thereof to a negative input terminal of the comparator.

Other aspects of embodiments of the inventive concept are directed to providing a memory system which comprises a host configured to provide a burst mode signal and a mode signal indicating a training interval of the burst mode signal; and at least one memory module configured to restore the burst mode signal to a data signal in response to the mode signal. The at least one memory module comprises a pre-amplifier configured to convert the burst mode signal into the voltage signal; a reference controller configured to determine a data reference signal of the voltage signal in response to a mode signal; and a main amplifier configured to restore the voltage signal to a data signal based on the data reference voltage. The training interval is an interval where the burst mode signal is DC balanced.

In exemplary embodiments, the at least one memory module is connected to the host via a channel and the host provides the reference controller with a channel signal indicating a channel through which the burst mode signal is transmitted.

In exemplary embodiments, in the training interval, the number of ‘1’ bits included in the burst mode signal is equal to the number of ‘0’ bits included in the burst mode signal.

In exemplary embodiments, the reference controller calculates an average of the voltage signal during the training interval of the burst mode signal in response to the mode signal and outputs the calculated average as the data reference voltage.

In exemplary embodiments, the training interval is included in a preamble interval of the burst mode signal.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram schematically illustrating a memory device using a burst mode optical receiver and a memory system including the memory device, according to some embodiments of the inventive concept;

FIG. 2 is a block diagram schematically illustrating a burst mode optical receiver illustrated in FIG. 1, according to some embodiments of the inventive concept;

FIG. 3 is a block diagram schematically illustrating a burst mode optical receiver illustrated in FIG. 1, according to other embodiments of the inventive concept;

FIG. 4 is a timing diagram for describing a data transfer period of an amplified received signal while a data packet is transmitted by a packet unit;

FIG. 5 is a block diagram schematically illustrating an average/hold circuit illustrated in FIG. 3, according to some embodiments of the inventive concept;

FIG. 6 is a block diagram schematically illustrating an average/hold circuit illustrated in FIG. 3, according to other embodiments of the inventive concept;

FIG. 7 is a block diagram schematically illustrating an average/hold circuit illustrated in FIG. 3, according to still other embodiments of the inventive concept;

FIG. 8 is a block diagram schematically illustrating an average/hold circuit illustrated in FIG. 3, according to further embodiments of the inventive concept;

FIG. 9 is a block diagram schematically illustrating an average/hold circuit illustrated in FIG. 3, according to other embodiments of the inventive concept;

FIG. 10 is a block diagram schematically illustrating a memory system using a memory module including a burst mode optical receiver according to some embodiments of the inventive concept; and

FIG. 11 is a block diagram schematically illustrating an application of some embodiments of the inventive concept to a mobile device.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

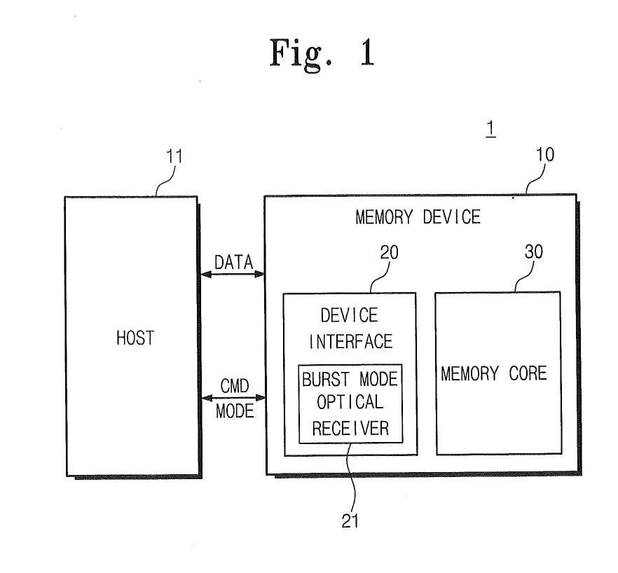

FIG. 1 is a block diagram schematically illustrating a memory device using a burst mode optical receiver and a memory system including the memory device, according to some embodiments of the inventive concept. Referring to FIG. 1, a memory system 1 includes a host 11 and a memory device 10 that stores data in response to a control of the host 11.

The memory device 10 receives a burst mode signal, provided from the host 11, through a burst mode optical receiver 21. The burst mode optical receiver 21 included in the memory device 10 measures or otherwise determines a data reference voltage of the burst mode signal using a preamble signal of the burst mode signal, in response to a mode signal MODE from the host 11.

The memory device 10 need not require a peak detector and/or a feedback circuit for a specific operation on the data reference voltage. Thus, memory device 10 stably generates the data reference voltage with relatively low complexity under a low-voltage condition. This will be more fully described with reference to accompanying drawings below.

The host 11 provides a command CMD for controlling a data input/output operation of the memory device 10. The host 11 receives data output from the memory device 10 and provides data to the memory device 10. Data may be exchanged between the host 11 and the memory device 10 using a burst packet type of burst mode signal.

The memory device 10 includes a device interface 20 and a memory core 30. The memory device 10 receives the burst mode signal transmitted from the host 11 via the device interface 20. The memory device 10 restores the burst mode signal to generate data. The memory device 10 stores the data generated in the memory core 30.

When a packet of the burst mode signal is switched, a level of a data reference voltage of the burst mode signal is varied. A data reference voltage of each packet may be detected to restore the burst mode signal the data reference voltage of which is varied by lapse of time. The device interface 20 according to some embodiments of the inventive concept may detect the data reference voltage of the burst mode signal using the burst mode optical receiver 21.

The burst mode optical receiver 21 may detect or otherwise determine a data reference voltage in response to the mode signal MODE provided from the host 11. The burst mode optical receiver 21 may determine a current or present transfer interval (e.g., a preamble interval or a payload interval) of the burst mode signal using the mode signal MODE. When the mode signal MODE is received, the burst mode optical receiver 21 detects or determines the data reference voltage of the burst mode signal based on the burst mode signal in the preamble interval.

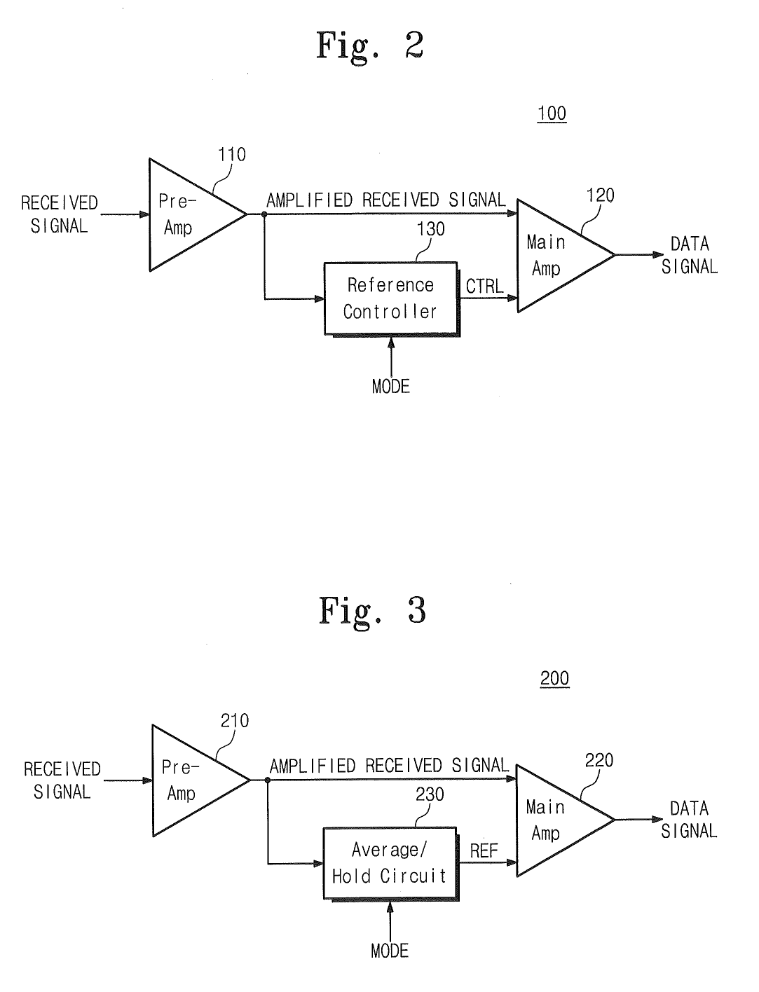

FIG. 2 is a block diagram schematically illustrating a burst mode optical receiver, such as that illustrated in FIG. 1, according to some embodiments of the inventive concept. A burst mode optical receiver 100 generates a data signal by restoring a received signal as a burst mode signal provided from a host.

The burst mode optical receiver 100 determines a transfer interval of the received signal in response to a mode signal MODE from the host. The burst mode optical receiver 100 detects a data reference voltage of the received signal based on the mode signal MODE and the received signal in the preamble interval. The burst mode optical receiver 100 generates the data signal using the detected data reference voltage. This will be more fully described below.

A pre-amplifier 110 receives the received data transmitted from the host. The pre-amplifier 110 may include an optical detector that converts an optical signal type of received signal into an electrical current signal. The pre-amplifier 110 generates an amplified received signal by converting the electrical current signal into a voltage signal. The pre-amplifier 110 outputs the amplified received signal.

A main amplifier 120 amplifies the amplified received signal to output a data signal. The main amplifier 120 maintains amplitude of the data signal constantly in response to a control signal CTRL provided from a reference controller 130.

The reference controller 130 detects or determines a data reference voltage of the amplified received signal provided from the pre-amplifier 110 in response to the mode signal MODE from the host. The reference controller 130 generates the control signal CTRL for controlling the main amplifier 120 based on the data reference voltage detected.

The reference controller 130 determines or detects a current or present transfer interval of the amplified received signal in response to the mode signal MODE. In particular, the reference controller 130 determines a preamble interval of the amplified received signal in response to the mode signal MODE. More particularly, the reference controller 130 may determine or identify a predetermined interval (e.g., a training interval) belonging to or during the preamble interval of the amplified received signal in response to the mode signal MODE.

The reference controller 130 detects or determines the data reference voltage of the amplified received signal using the amplified received signal during the training interval of the preamble interval. For example, the reference controller 130 may detect or determine the data reference voltage by calculating an average of the amplified received signal input during the training interval. The reference controller 130 outputs the control signal CTRL based on the determined result.

The burst mode optical receiver 100 detects or otherwise determines a data reference voltage of a received signal using the received signal during a preamble interval in response to the mode signal MODE provided from the host. Since the burst mode optical receiver 100 need not require a peak detector and a feedback circuit for detecting a data reference voltage, it may stably generate the data reference voltage with relatively low complexity under a low-voltage condition.

FIG. 3 is a block diagram schematically illustrating a burst mode optical receiver illustrated in FIG. 1, according to other embodiments of the inventive concept. Referring to FIG. 3, a burst mode optical receiver 200 includes a pre-amplifier 210, a main amplifier 220, and an average/hold circuit 230. The pre-amplifier 210 and the main amplifier 220 illustrated in FIG. 3 may be substantially similar to corresponding components illustrated in FIG. 2.

The average/hold circuit 230 has a plurality of driving modes. The average/hold circuit 230 may operate in a mode selected from the plurality of driving modes. The driving modes of the average/hold circuit 230 include an average mode and a hold mode. During the average mode, the average/hold circuit 230 calculates an average of an amplified received signal. During the hold mode, the average/hold circuit 230 holds and output the average calculated during the average mode.

A driving mode of the average/hold circuit 230 is selected in response to a mode signal MODE provided from a host. The average/hold circuit 230 is configured to operate in the average mode during a preamble interval in response to the mode signal MODE. Or, the average/hold circuit 230 is configured to operate in the average mode during a predetermined interval included in the preamble interval. The average/hold circuit 230 calculates an average of an amplified received signal provided during the average mode. The average/hold circuit 230 outputs the calculated average as a data reference voltage of the amplified received signal.

The average/hold circuit 230 is configured to operate in a hold mode during a payload interval in response to the mode signal MODE. In the payload interval, the average/hold circuit 230 outputs the average calculated during the preamble interval as the data reference voltage REF. The average/hold circuit 230 responds to the mode signal MODE to hold the data reference voltage until the payload interval ends.

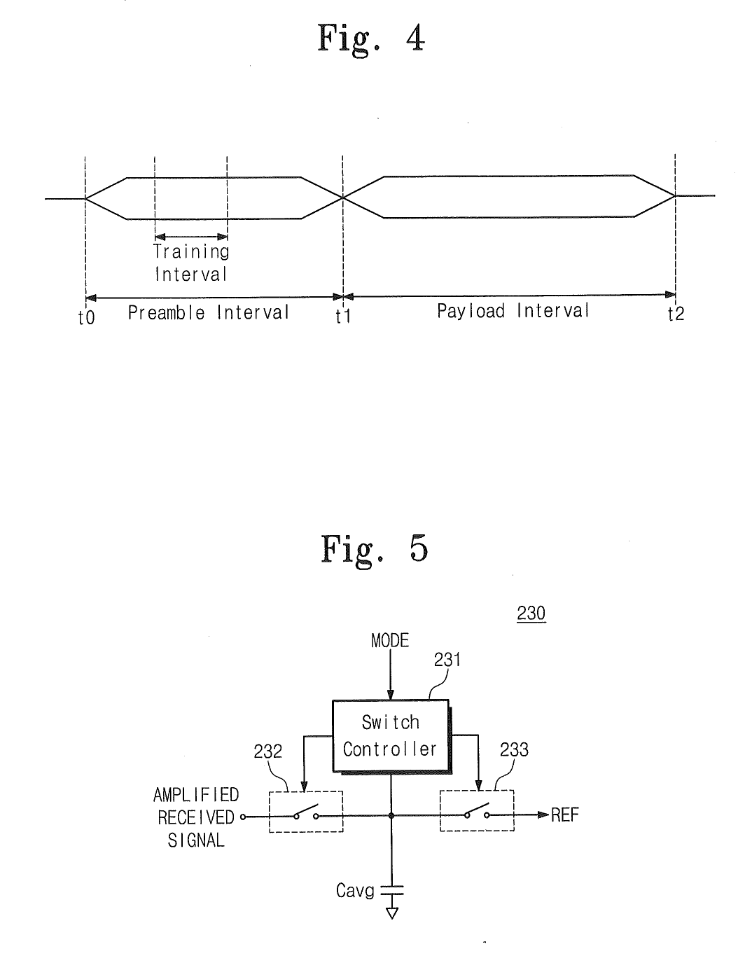

The amplified received signal may satisfy a predetermined condition to use an average of an amplified received signal provided during a predetermined interval belonging to a preamble interval as a data reference voltage of an amplified received signal. This will be more fully described with reference to FIG. 4.

FIG. 4 is a timing diagram for describing a data transfer period of an amplified received signal while a data packet is transmitted by a packet unit. Referring to FIG. 4, a data transfer interval of an amplified received signal includes a preamble interval and a payload interval.

The payload interval is an interval where data is transmitted. The preamble interval precedes the payload interval, and is an interval where information for restoring data transmitted in the payload interval is transferred. The preamble interval includes at least one training interval. A location and a length of the training interval may be variable within the preamble interval.

In embodiments of the inventive concept, an amplified received signal is a DC balanced signal in or during the training interval. That is, the number of ‘1’ bits of an amplified received signal transferred during the training interval is the same as that of ‘0’ bits thereof. For example, the amplified received signal is a signal having such a pattern that a sequence of ‘1’ bits and a sequence of ‘0’ bits are in turn received during the training interval. However, embodiments of the inventive concept are not limited thereto.

In the same data packet, a data reference voltage of the preamble interval is the same as that of the payload interval. Thus, a burst mode optical receiver according to some embodiments of the inventive concept may detect or determine a data reference signal of an amplified received signal by calculating an average of the amplified received signal transferred during the training interval belonging to the preamble interval.

FIG. 5 is a block diagram schematically illustrating an average/hold circuit illustrated in FIG. 3, according to some embodiments of the inventive concept. Referring to FIG. 5, an average/hold circuit 230 includes a switch controller 231, a first switch 232, a second switch 233, and an average capacitor Cavg.

An input terminal of the average/hold circuit 230 may be connected to a pre-amplifier 210 (refer to FIG. 3). The average/hold circuit 230 receives an amplified received signal through the input terminal. The input terminal is connected to the average capacitor Cavg through the first switch 232.

An output terminal of the average/hold circuit 230 may be connected to a main amplifier 230 (refer to FIG. 3). The average/hold circuit 230 provides a data reference voltage REF to the main amplifier 230 through the output terminal. The output terminal is connected to the average capacitor Cavg through the second switch 233.

The switch controller 231 may operate in one among a plurality of driving modes corresponding to a mode signal MODE provided from a host. The switch controller 231 selectively turns on the first and second switches 232 and 233 according to a driving mode. For example, in an average mode, the switch controller 231 turns the first switch 232 on and turns the second switch 233 off. In a hold mode, the switch controller 231 turns the first switch 232 off and turns the second switch 233 on.

During a training interval, the switch controller 231 operates in the average mode in response to the mode signal MODE. During the training interval, the switch controller 231 turns the first switch 232 on and turns the second switch 233 off.

When the first switch 232 is turned on, the amplified received signal is provided to the average capacitor Cavg. The average capacitor Cavg is charged by a DC component of the amplified received signal. A voltage charged in the average capacitor Cavg may direct or provide a data reference voltage of the amplified received signal.

During the payload interval, the switch controller 231 operates in the hold mode in response to the mode signal MODE. During the payload interval, the switch controller 231 turns the first switch 232 off and turns the second switch 233 on.

When the first switch 232 is turned off, a voltage charged in the average capacitor Cavg is held. The voltage charged in the average capacitor Cavg is output as a data reference voltage REF through the second switch 233.

The average/hold circuit 230 calculates an average value of an amplified received signal using the capacitor Cavg and the first and second switches 232 and 233 connected to the average capacitor Cavg, and holds the calculated result. Since an operating mode of the average/hold circuit 230 is controlled by the mode signal MODE, the average/hold circuit 230 is implemented by a circuit with relatively low complexity.

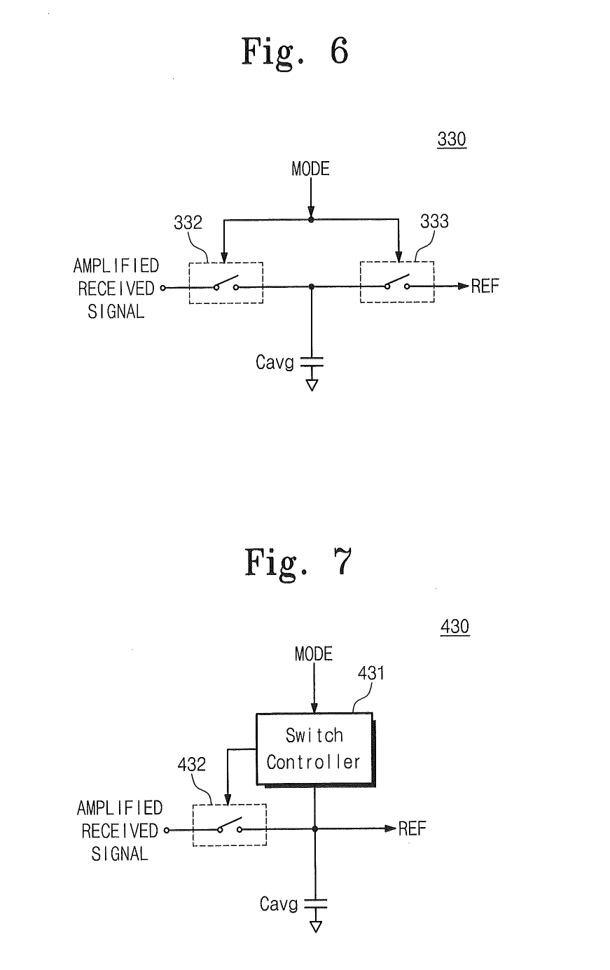

FIG. 6 is a block diagram schematically illustrating an average/hold circuit illustrated in FIG. 3, according to other embodiments of the inventive concept. A first switch 332, a second switch 333, and an average capacitor Cavg in FIG. 6 may be substantially similar to corresponding components in FIG. 5.

In contrast to the average/hold circuit 230 illustrated in FIG. 5, an average/hold circuit 330 may not include a switch controller 231 illustrated in FIG. 5. Instead, the first and second switches 332 and 333 of the average/hold circuit 330 operate directly in response to a mode signal MODE.

In FIG. 6, an amplified received signal provided to the average/hold circuit 330 is DC balanced in a preamble interval. That is, in FIG. 6, a training interval of an amplified received signal covers the whole of the preamble period. Thus, the average/hold circuit 230 operates in an average mode on the whole preamble period in response to the mode signal MODE.

FIG. 7 is a block diagram schematically illustrating an average/hold circuit illustrated in FIG. 3, according to still other embodiments of the inventive concept. An average/hold circuit 430 includes a switch controller 431, a first switch 432, and an average capacitor Cavg.

During a training interval, the switch controller 431 operates in an average mode in response to a mode signal MODE. During the training interval, the switch controller 431 turns the first switch 432 on.

When the first switch 232 is turned on, an amplified received signal is provided to the average capacitor Cavg. The average capacitor Cavg is charged by a DC component of the amplified received signal. A voltage charged in the average capacitor Cavg may direct or provide a data reference voltage of the amplified received signal.

During a payload interval, the switch controller 431 operates in a hold mode in response to the mode signal MODE. During the payload interval, the switch controller 431 turns the first switch 232 off.

When the first switch 432 is turned off, a voltage charged in the average capacitor Cavg is held. The voltage charged in the average capacitor Cavg is output as a data reference voltage REF through the second switch 233.

In contrast to the average/hold circuit 230 illustrated in FIG. 5, the average capacitor Cavg illustrated in FIG. 7 is directly connected to an output terminal of the average/hold circuit 430 without passing through a switch. Since the average capacitor Cavg illustrated in FIG. 7 is always connected to the output terminal, it is possible to reduce or prevent an instant float phenomenon of the average capacitor Cavg. With the above-described structure of the average/hold circuit 430, it is possible to prevent an unwanted peak voltage from being generated by floating of the average capacitor Cavg.

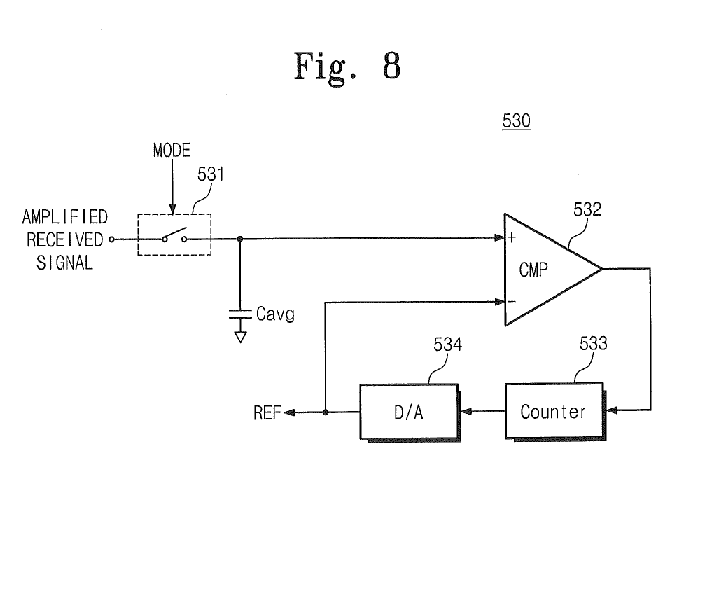

FIG. 8 is a block diagram schematically illustrating an average/hold circuit illustrated in FIG. 3, according to further embodiments of the inventive concept. An average/hold circuit 530 includes a first switch 531, a comparator 532, a counter 533, a digital-to-analog converter 534, and an average capacitor Cavg.

An average/hold circuit 530 illustrated in FIG. 8 may output a digitized voltage as a reference data voltage REF. The average/hold circuit 530 may compensate for a leakage current generated by an average capacitor Cavg and/or errors caused by noise by digitizing an output.

An input terminal of the average/hold circuit 530 may be connected to a pre-amplifier 210 (refer to FIG. 3). The average/hold circuit 530 receives an amplified received signal through the input terminal. The input terminal is connected to one end of the average capacitor Cavg through the first switch 532. The other end of the average capacitor Cavg is grounded.

The first switch 531 may operate in one among a plurality of driving modes corresponding to a mode signal MODE provided from a host. For example, in an average mode, the first switch 531 is turned on. In a hold mode, the first switch 531 is turned off.

During a training interval, the first switch 531 operates in the average mode in response to the mode signal MODE. When the first switch 531 is turned on, an amplified received signal is provided to the average capacitor Cavg. The average capacitor Cavg is charged by a DC component of the amplified received signal. A voltage charged in the average capacitor Cavg may direct or provide a data reference voltage of the amplified received signal.

During a payload interval, the first switch 531 operates in a hold mode in response to the mode signal MODE. When the first switch 531 is turned off, a voltage charged in the average capacitor Cavg is held.

An output terminal of the average/hold circuit 530 may be connected to a main amplifier 230 (refer to FIG. 3). The average/hold circuit 530 provides a data reference voltage REF to the main amplifier 230 through the output terminal.

The comparator 532 compares a voltage of the average capacitor Cavg charged during an average mode of operation and the data reference voltage REF. The comparator 532 provides the comparison result to the counter 533.

The counter 533 updates a count in response to the comparison result of the comparator 532. The counter 533 increases the count when a voltage charged in the average capacitor Cavg is higher than the data reference voltage REF. If the data reference voltage REF reaches the voltage charged in the average capacitor Cavg, the counter 533 holds the count.

The updated count of the counter 533 may be stored in a register. The counter 533 provides the updated count to the digital-to-analog converter 534.

The digital-to-analog converter 534 generates the data reference voltage REF in response to the count provided from the counter 533. For example, the digital-to-analog converter 534 generates the data reference voltage REF based on a data reference voltage table. The data reference voltage table includes a relation between count values and predetermined voltage levels. The digital-to-analog converter 534 selects a voltage level, corresponding to a count, from among voltage levels stored in the data reference voltage table and outputs the selected voltage level as the data reference voltage REF. The digital-to-analog converter 534 provides the data reference voltage REF to an output terminal and the comparator 532.

The average/hold circuit 530 calculates an average value of an amplified received signal using the capacitor Cavg and the first switch 531 and holds the calculated result. Since an operating mode of the average/hold circuit 530 is controlled by the mode signal MODE, the average/hold circuit 530 is implemented by a circuit with relatively low complexity.

In addition, since the data reference voltage REF output from the average/hold circuit 530 is a digital value closest to an analog voltage charged in the average capacitor Cavg, it outputs a stable value without influence of a leakage current generated by the average capacitor Cavg and a noise.

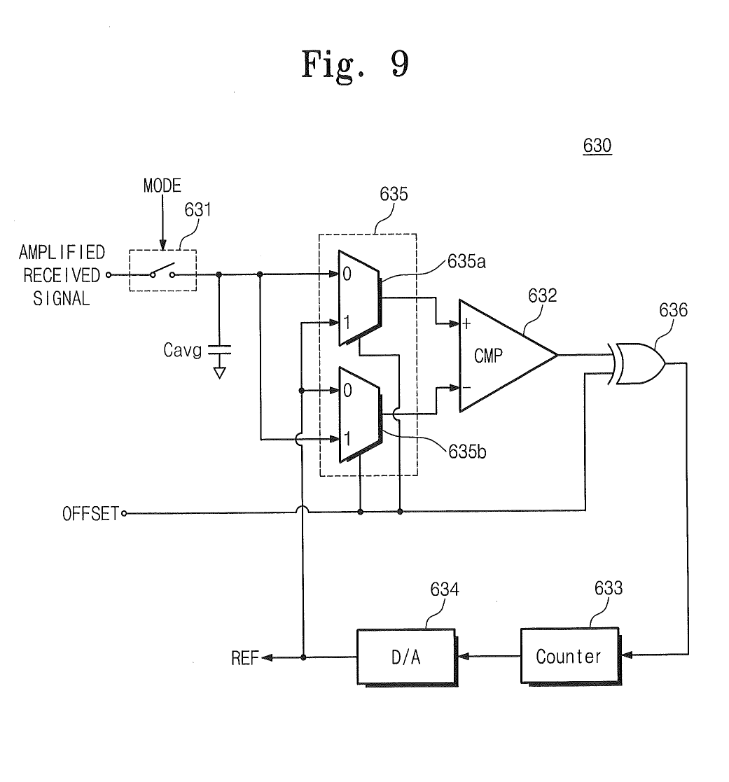

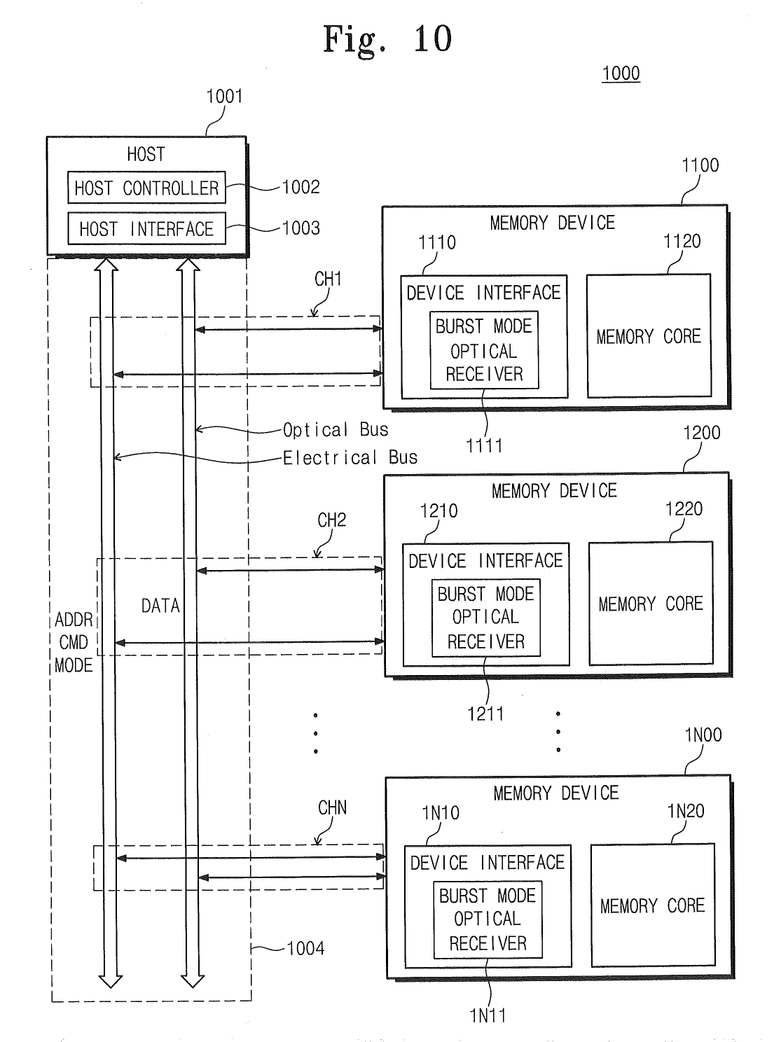

FIG. 9 is a block diagram schematically illustrating an average/hold circuit illustrated in FIG. 3, according to other embodiments of the inventive concept. An average/hold circuit 630 includes a first switch 631, a comparator 632, a counter 633, a digital-to-analog converter 634, a multiplexer unit 635, an XOR gate 636, and an average capacitor Cavg.

As compared to an average/hold circuit 530 illustrated in FIG. 8, the average/hold circuit 630 illustrated in FIG. 9 further includes the multiplexer unit 635 and the XOR gate 636. The average/hold circuit 630 compensates for an error between a voltage charged in the average capacitor Cavg and a data reference voltage REF output from the average/hold circuit 630 using the multiplexer unit 635 and the XOR gate 636.

The components 631, 632, 633, 634, and Cavg illustrated in FIG. 9 may be substantially similar to corresponding components illustrated in FIG. 9.

The multiplexer unit 635 is connected to the average capacitor Cavg to be provided with a voltage charged during an average mode. Also, the multiplexer unit 635 is connected to the digital-to-analog converter 634 to be supplied with a data reference voltage REF.

The multiplexer unit 635 includes a first multiplexer 635a and a second multiplexer 635b. An output of the first multiplexer 635a is connected to a positive input terminal of the comparator 632. An output of the second multiplexer 635b is connected to a negative input terminal of the comparator 632.

The first multiplexer 635a and the second multiplexer 635b are connected to the average capacitor Cavg and the digital-to-analog converter 634 to be provided with a voltage charged in the average capacitor Cavg during an average mode and the data reference voltage REF. Also, an offset voltage OFFSET is provided to the first and second multiplexers 635a and 635b. The first and second multiplexers 635a and 635b select one of the voltage charged in the average capacitor Cavg and the data reference voltage REF.

Voltages output from the first and second multiplexers 635a and 635b may be complementary to each other. For example, when the first multiplexer 635a outputs the voltage charged in the average capacitor Cavg, the second multiplexer 635b outputs the data reference voltage REF. On the other hand, when the first multiplexer 635a outputs the data reference voltage REF, the second multiplexer 635b outputs the voltage charged in the average capacitor Cavg.

The average/hold circuit 630 provides an output of the digital-to-analog converter 634 to both a positive input terminal and a negative input terminal of the comparator 632 using the multiplexer unit 635. Thus, the average/hold circuit 630 compensates for an error between a voltage charged in the average capacitor Cavg and a data reference voltage REF output from the average/hold circuit 630.

FIG. 10 is a block diagram schematically illustrating a memory system using a memory module including a burst mode optical receiver according to some embodiments of the inventive concept. Referring to FIG. 10, a memory system 1000 includes a host 1001 and a plurality of memory modules 1100 to 1N00.

The host 1001 includes a host controller 1002 and a host interface 1003. The host 1001 communicates with the plurality of memory modules 1100 to 1N00 using the host interface 1003. The host interface 1003 is connected to the plurality of memory modules 1100 to 1N00 through a bus 1004 and a plurality of channels CH1 to CHN communicating with the bus 1004.

The bus 1004 includes an optical bus having an optical waveguide and an electrical bus for transmitting an electrical signal. The bus 1004 transmits and receives data through the optical bus. The bus 1004 transmits and receives a command, an address, and a mode signal through the electrical bus. However, the inventive concept is not limited thereto. For example, the bus 1004 may transmit and receive a command, an address, and a mode signal through the optical bus.

The memory module 1100 includes a device interface 1110 and a memory core 1120. The memory module 1100 receives a burst mode signal provided through the bus 1004 from the host 1001, using a burst mode optical receiver 1111 included in the device interface 1110. The burst mode optical receiver 1111 included in the device interface 1110 operates in response to a mode signal provided from the host 1001 and measures or determines a data reference voltage of a burst mode signal using a preamble signal of the burst mode signal.

The host 1001 provides a command CMD for controlling a data input/output operation of the memory module 1100 and a mode signal MODE. Also, the host 1001 exchanges data with the memory module 1100. Data is exchanged between the host 1001 and the memory module 1100 through the optical bus of the bus 1004 as a burst packet type of burst mode signal.

The memory module 1100 receives the burst mode signal transferred from the host 1001 through the device interface 1110. The memory module 1100 restores the burst mode signal to generate data. The memory module 1100 stores the data thus generated in the memory core 1120. The memory core 1120 is formed of a plurality of memories.

When a packet of the burst mode signal is switched, a level of a data reference voltage of the burst mode signal is varied. The device interface 1110 of the memory module 1100 detects or determines a data reference voltage of the burst mode signal using the burst mode optical receiver 1111.

The burst mode optical receiver 1111 may detect or determine a data reference voltage in response to the mode signal MODE provided from the host 1001. The burst mode optical receiver 1111 may determine a current or present transfer interval (e.g., a preamble interval or a payload interval) of the burst mode signal using the mode signal MODE. When the mode signal MODE is received, the burst mode optical receiver 1111 detects or determines the data reference voltage of the burst mode signal based on the burst mode signal in the preamble interval.

The memory system 1000 may use a common control unit to control data reference voltage detecting operations of the memory modules 1100 to 1N00. The memory system 1000 may control an average/hold circuit included in a burst mode optical receiver of each memory module using the common control unit. The common control unit may selectively control an average/hold circuit (as described with reference to FIGS. 3 to 9) connected to each channel in response to a mode signal MODE and a channel selection signal provided from the host 1001. With the above-described selection operation, the memory system 1000 may perform a data reference voltage detecting operation on the memory modules 1100 to 1 N00.

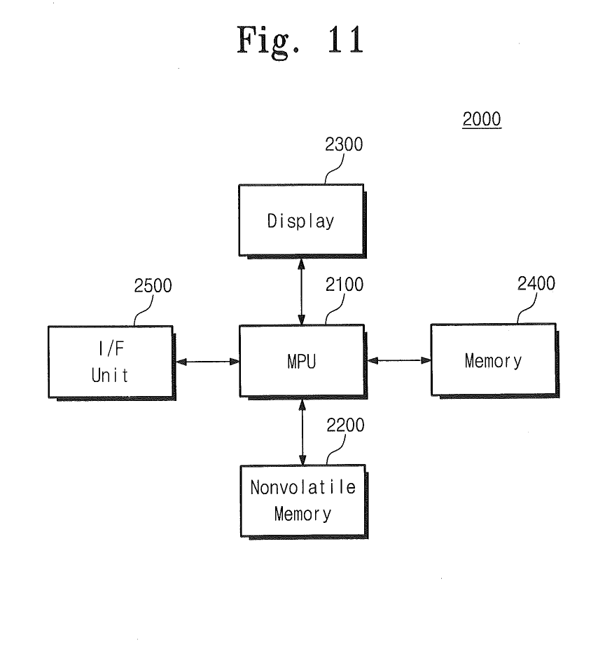

FIG. 11 is a block diagram schematically illustrating an application of the inventive concept to a mobile device.

Referring to FIG. 11, a mobile device 2000, for example, may be a notebook computer or a handheld electronic device, and includes a Micro Processing Unit (MPU) 2100, a nonvolatile memory 2200, a display 2300, a memory 2400, and an interface unit 2500.

In some cases, the MPU 2100, the nonvolatile memory 2200, and/or the memory 2400 may be integrated or packaged in a chip. For example, the nonvolatile memory 2200 and the memory 2400 may be embedded in the mobile device 2000.

In the event that the mobile device 2000 is a handheld communications device, the interface unit 2500 may be connected to a modem and a transceiver that transmit and receive communications data and modulates and demodulates data.

The MPU 2100 controls an overall operation of the mobile device 2000 according to a predetermined program.

The memory 2400 is connected to the MPU 2100, and is used as a buffer memory or a main memory of the MPU 2100. The memory 2400 may include a burst mode optical receiver configured as illustrated in FIG. 1. The memory 2400 receives a burst mode signal provided from the MPU 2100 using the burst mode optical receiver, in a memory system. The memory 2400 operates in response to a mode signal MODE provided from the MPU 2100, and measures or determines a data reference voltage of a burst mode signal using a preamble signal of the burst mode signal. Since the memory 2400 does not require a peak detector and a feedback circuit for detecting a data reference voltage, the memory system 2000 including the memory 2400 transmits and receives data with relatively low complexity under a low-voltage condition.

The nonvolatile memory 2200 may be a NOR or NAND flash memory.

The display 2300 may include a liquid crystal display having a backlight, a liquid crystal display having an LED light source, and/or a touch screen (e.g., OLED). The display 2300 may be an output device for displaying images (e.g., characters, numbers, pictures, etc.) in color.

In the above embodiments, the mobile device 2000 has been described with reference to a mobile communications device. In some cases, however, the mobile device 2000 may be used as a smart card by adding or removing components. The mobile device 2000 may be connected to an external communications device through a separate interface. The communications device may be a DVD player, a computer, a set top box (STB), a game machine, a digital camcorder, or the like. Although not shown in FIG. 11, the mobile device 2000 may further include an application chipset, a camera image processor (CIS), a mobile DRAM, etc.

Chips of the mobile device 2000 may be mounted independently or using various packages. For example, a chip may be packed by a package such as PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), System In Package (SIP), Multi Chip Package (MCP), Wafer-level Fabricated Package (WFP), Wafer-Level Processed Stack Package (WSP), or the like.

The nonvolatile memory 2200 may store various types of data information such as text, graphics, software codes, and so on.

The nonvolatile memory 2200, for example, may be implemented by EEPROM (Electrically Erasable Programmable Read-Only Memory), flash memory, MRAM (Magnetic RAM), STT-MRAM (Spin-Transfer Torque MRAM), CBRAM (Conductive bridging RAM), FeRAM (Ferroelectric RAM), PRAM (Phase change RAM) called OUM (Ovonic Unified Memory), RRAM or ReRAM (Resistive RAM), nanotube RRAM, PoRAM (Polymer RAM), NFGM (Nano Floating Gate Memory), holographic memory, molecular electronics memory device, or insulator resistance change memory.

While the inventive concept has been described with reference to exemplary embodiments, it will be apparent to those skilled in the art that various changes and modifications may be made without departing from the spirit and scope of the present invention. For example, modifications or changes on a pre-amplifier, an average/hold circuit, and a main amplifier may be made according to the application and/or environment. Therefore, it should be understood that the above embodiments are not limiting, but illustrative.

What is claimed is:

1. A burst mode optical receiver, comprising:
a pre-amplifier configured to convert a burst mode signal into a voltage signal;
a reference controller configured to determine a data reference voltage of the voltage signal in response to a mode signal from a host, the mode signal indicating a training interval in which the burst mode signal is DC balanced; and
a main amplifier configured to restore the voltage signal to a data signal based on the data reference voltage.

2. The burst mode optical receiver of claim 1, wherein in the training interval, a number of ‘1’ bits included in the burst mode signal is equal to a number of ‘0’ bits included in the burst mode signal.

3. The burst mode optical receiver of claim 2, wherein in the training interval, the burst mode signal is a signal having such a pattern that at least one of the ‘1’ bits and at least one of the ‘0’ bits or a sequence of the ‘1’ bits and a sequence of the ‘0’ bits are in turn received.

4. The burst mode optical receiver of claim 1, wherein the main amplifier is configured to restore the voltage signal to the data signal having a predetermined uniform amplitude based on the data reference voltage.

5. The burst mode optical receiver of claim 1, wherein the reference controller is configured to calculate an average of the voltage signal during the training interval of the burst mode signal in response to the mode signal and is configured to output the calculated average as the data reference voltage.

6. The burst mode optical receiver of claim 5, wherein the reference controller comprises an average/hold circuit configured to operate in one of a plurality of driving modes,
wherein the driving modes of the average/hold circuit comprise an average mode for calculating the average of the voltage signal and a hold mode for holding the calculated average to be output as the data reference voltage, and
wherein the average/hold circuit is configured to operate in one of the average mode and the hold mode in response to the mode signal.

7. The burst mode optical receiver of claim 6, wherein the average/hold circuit comprises:
an average capacitor;
a first switch configured to provide the voltage signal to the average capacitor in the average mode, in response to the mode signal; and
a second switch configured to output a voltage stored in the average capacitor as the data reference voltage in the hold mode, in response to the mode signal.

8. The burst mode optical receiver of claim 6, wherein the average/hold circuit comprises:
an average capacitor;
a switch configured to provide the voltage signal to the average capacitor in the average mode, in response to the mode signal; and
a comparator configured to compare a voltage stored in the average capacitor and the data reference voltage;
a counter configured to update a count value in response to a comparison result of the comparator; and
a digital-to-analog converter configured to generate the data reference voltage as a digital value based on the count value.

9. The burst mode optical receiver of claim 8, wherein the counter is configured to increase the count value in response to the voltage stored in the average capacitor being higher than the data reference voltage, and
wherein the digital-to-analog converter is configured to generate the data reference voltage having a level that is increased in proportion to an increase in the count value.

10. The burst mode optical receiver of claim 8, wherein the average/hold circuit further comprises:
a multiplexer configured to provide one of the voltage stored in the average capacitor and the data reference voltage to a positive input terminal of the comparator and the other thereof to a negative input terminal of the comparator.

11. A memory system, comprising;
a host configured to provide a burst mode signal and a mode signal indicating a training interval of the burst mode signal; and
at least one memory module configured to restore the burst mode signal to a data signal in response to the mode signal,
wherein the at least one memory module comprises a pre-amplifier configured to convert the burst mode signal into a voltage signal; a reference controller configured to determine a data reference voltage of the voltage signal in response to the mode signal; and a main amplifier configured to restore the voltage signal to the data signal based on the data reference voltage, and
wherein the training interval comprises an interval of the burst mode signal during which the burst mode signal is DC balanced.

12. The memory system of claim 11, wherein the at least one memory module is connected to the host via a channel, and wherein the host is configured to provide the reference controller with a channel signal indicating the channel through which the burst mode signal is transmitted.

13. The memory system of claim 11, wherein during the training interval, the number of ‘1’ bits included in the burst mode signal is equal to the number of ‘0’ bits included in the burst mode signal.

14. The memory system of claim 11, wherein the reference controller is configured to calculate an average of the voltage signal during the training interval of the burst mode signal in response to the mode signal and is configured to output the calculated average as the data reference voltage.

15. The memory system of claim 11, wherein the training interval is included in a preamble interval of the burst mode signal.

16. A burst mode optical receiver, comprising:
a reference controller configured to receive a voltage signal generated from an optical burst mode signal and determine a reference voltage therefor in response to a mode signal indicating a training interval of the voltage signal, wherein, during the training interval, the voltage signal is DC balanced such that a same number of ‘1’ bits and ‘0’ bits are indicated thereby.

17. The receiver of claim 16, wherein the reference controller is configured to calculate an average of the voltage signal over the training interval in response to the mode signal to determine the reference voltage.

18. The receiver of claim 17, wherein the reference controller is configured to hold and output the reference voltage outside of the training interval responsive to determination thereof.

19. The receiver of claim 18, wherein the reference controller is configured to switch between operation to calculate the average of the voltage signal and operation to hold and output the reference voltage in response to the mode signal.

20. The receiver of claim 19, further comprising:
a main amplifier configured to maintain an amplitude of the voltage signal in response to a control signal from the reference controller to output a data signal, wherein the control signal indicates the reference voltage,
wherein the reference controller is configured to determine the reference voltage without use of a peak detector.
